(19) United States
(12) Patent Application Publication
(10) Pub. No.: US 2011/0131126 A1
(43) Pub. Date: Jun. 2, 2011

(54) Trade Management System For Reducing Securities Positions

(75) Inventors: Vinayek K. Singh, Litchfield, CT (US); Ashok H. Mital, Tinton Falls, NJ (US); Malcom P. Walley, Gulford, CT (US); Stephen Richard Gould, Merrick, NY (US)

(73) Assignee: Vyapar Capital Market Partners LLC

(21) Appl. No.: 12/626,691

(22) Filed: Nov. 27, 2009

(51) Int. Cl. G06Q 40/00

(52) U.S. Cl. 705/37

(57) ABSTRACT

A computer implemented method and system is provided for reducing the number of securities positions of multiple counterparties. Securities positions are acquired from the counterparties. A price is obtained for each of the acquired securities positions from each of the counterparties. A consensus price is created for each of the acquired securities positions based on the obtained price of each of the acquired securities positions. The created consensus price for each of the acquired securities positions is displayed to the counterparties. The counterparties perform acceptance or rejection of the created consensus price of each of the acquired securities positions. The acquired securities positions are allocated at the created consensus price to one or more counterparties who accept the consensus price, using a sorting algorithm. The number of securities positions of the counterparties is reduced by trading the allocated securities positions to the associated counterparties.

### CROSS REFERENCE TO RELATED APPLICATIONS

The following patent is incorporated herein by reference in its entirety: Non-provisional patent application Ser. No. 12/247,392 titled “Trade Risk Management”, filed on Oct. 8, 2008 in the United States Patent and Trademark Office.

### BACKGROUND

The computer implemented method and system disclosed herein, in general, relates to trade management. More particularly, the computer implemented method and system disclosed herein relates to reducing number of securities positions of multiple counterparties.

The security positions of counterparties comprising small holdings herein referred to as odd lots or securities held by the counterparty for a relatively long time herein referred to as aged positions, are considerably difficult to trade. The prices of the securities positions traded in large amounts, i.e., institutional pricing are more favorable than the prices at which odd lots, i.e., odd lot pricing and aged positions are traded. Typically, a trading firm is compelled to trade the odd lots and aged positions at a lower price.

Typically, trading institutions have many odd lot positions resulting from purchases from smaller clients, or the incomplete sale of existing positions, or a short sale to smaller clients. The prices at which the odd lot trades take place are higher for sales to clients and lower for purchases from clients as compared to the institutional pricing. Furthermore, the trading of odd lots takes place at odd lot prices. Hence, the potential benefit of opening a position at a price favorable in comparison with the institutional price is often lost.

Trading institutions also commonly have securities positions on their books for some considerable time. The length of time for which a position is held as to constitute an aged position varies from firm to firm, all firms dislike having odd lot and aged positions.

Furthermore, an aged position ties up capital, utilizes other resources and is economically inefficient for trading firms to hold. Generally, as an incentive to get salespeople to sell the aged positions to clients, trade firms with aged positions increase commission paid for sales substantially above that paid for normal security transactions. However, the commission is charged to the trade firm's profit-and-loss account and reduces effective price for a sale or increases the effective price for a purchase of the transaction. Furthermore, even without sales incentives aged positions are traded at prices unfavorable compared to the market price for non aged positions.

Hence, there is an unmet need for reducing a trading firm's securities positions, for example, odd lot positions and aged positions, by trading the securities positions at institutional prices.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for reducing the number of securities positions, for example, odd lot positions and aged positions, of multiple counterparties by trading the securities positions at institutional prices. Securities positions are acquired from the counterparties. The counterparties are, for example, buyers and sellers of the securities positions. The securities positions are, for example, odd lot positions and aged positions of the counterparties. The acquired securities positions comprise holdings of the counterparties.

A price is obtained for each of the acquired securities positions from each of the counterparties associated with the acquired securities positions. A consensus price is created for each of the acquired securities positions based on the obtained price of each of the acquired securities positions. The created consensus price for each of the acquired securities positions is displayed to the counterparties in an online environment. The counterparties may accept or reject the created consensus price of the acquired securities positions. The counterparties who reject the created consensus price for each of the securities positions are eliminated from allocation of the securities positions. The acquired securities positions at the created consensus price are allocated to one or more counterparties who accept the created consensus price, using a sorting algorithm. The sorting algorithm allocates the acquired securities positions to the counterparties based on predefined rules. Allocation of the acquired securities positions to one or more counterparties at the created consensus price is performed to consolidate the holdings of the securities positions and to reduce the number of different securities held by each of the counterparties such that change of risk position is within constraints imposed by the counterparties.

A change in risk position of the counterparties resulting from the allocated securities positions is calculated. A hedging amount for hedging the calculated change in the risk position of the counterparties is calculated. The calculated hedging amount is assigned to each of the counterparties. Trade reports are generated for each of the counterparties. The trade reports comprise, for example, outcome of the allocation and details of the trade. Transactions resulting from the allocation and hedge calculations are generated and a confirmation of the generated transactions is sent to the counterparties. The number of securities positions of the counterparties is reduced by trading the allocated securities positions to the counterparties associated with the allocated securities positions.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method of reducing the number of securities positions of multiple counterparties.

FIG. 2 illustrates a computer implemented system for reducing the number of securities positions of multiple counterparties.

FIG. 3 exemplarily illustrates the architecture of a computer system employed in a trade management server and computing devices used by the counterparties in a network.

FIG. 4 exemplarily illustrates multiple counterparties connected to the trade management server via the network.

FIG. 5 exemplarily illustrates the submission of securities positions information from one of the counterparties.

FIG. 6 exemplarily illustrates a generated trade report of allocated securities positions.

### DETAILED DESCRIPTION OF THE INVENTION

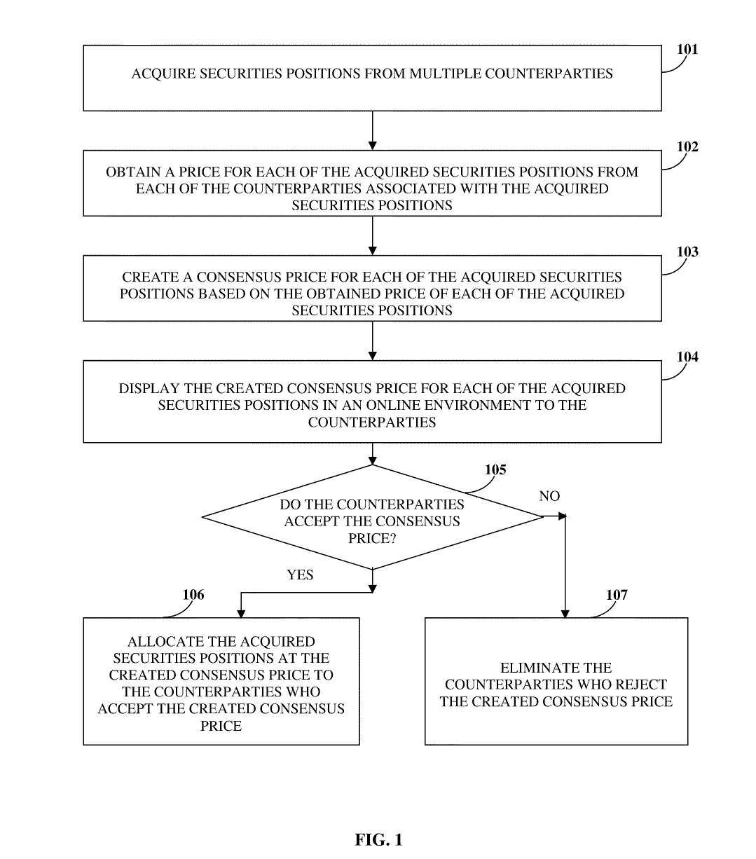

FIG. 1 illustrates a computer implemented method of reducing the number of securities positions of multiple counterparties. As used herein, the term “securities” refers to financial instruments, for example, shares, bonds, etc. that represent a value. The number of securities bought or sold by a person, a firm, or an institution is herein referred to as “securities positions”. The securities positions, for example, line items, are reduced by trading the securities positions at an institutional price. The counterparties are, for example, trading firms, buyers, and sellers of the securities positions. The securities positions are acquired 101 from the counterparties. The securities positions are, for example, odd lot positions and aged positions of the counterparties. The security positions of counterparties comprising small holdings are herein referred to as “odd lots”. The securities positions held by the counterparty for a relatively long time are herein referred to as “aged positions”. The securities positions comprise holdings of the counterparties. A price is obtained 102 for the each of the acquired securities positions from each of the counterparties associated with the acquired securities positions. The price obtained for the securities positions by the counterparties are priced halfway between the price at which institutional amounts of the securities are bought and the price at which the institutional amounts of the securities are sold, known as institutional mid-market price. The obtained price is, for example, the difference between yield to maturity of the bonds and the yield to maturity of a United States treasury (UST) bond with a comparable maturity. The obtained price is called a spread. For example, if the obtained price is in the form of a price or a yield, the spread is calculated. Different parameters, for example, yield, spread, etc. are calculated using programmable systems, for example, bloomberg terminals, excel, etc.

A consensus price is created 103 for the each of the acquired securities positions based on the obtained price of the acquired securities positions. For example, for each of the securities, if more than one of the counterparties has a securities position, the average of the obtained prices is calculated. The calculated average is, for example, used as the consensus price for each of the securities positions. The created consensus price for each of the acquired securities positions is displayed 104 to the counterparties in an online environment, for example, on a website hosted by a trade management server connected to the counterparties via a network. Pricing information of the obtained price and the created consensus price of each of the acquired securities positions is stored on the trade management server.

The counterparties may accept or reject 105 the created consensus price of the each of the acquired securities positions. The counterparties who reject the created consensus price of the securities positions are eliminated 107 from allocation of the acquired securities positions. The acquired securities positions are allocated 106 at the created consensus price to one or more counterparties who accept the created consensus price, using a sorting algorithm. By accepting the created consensus price, the counterparties undertake to accept purchases or sales of the securities positions at that created consensus price.

The sorting algorithm allocates the acquired securities positions of the counterparties based on predefined rules. The predefined rules are, for example, a size rule, a sign rule, a single counterparty rule, a sorting rule, etc. According to the size rule, a securities position can be allocated to a counterparty only if the counterparty holds a position of at least a predefined value in the security. According to the sign rule, a securities position can be allocated to a counterparty only if the counterparty holds a position in the security of the same sign as the aggregated securities. According to the single counterparty rule, if only one counterparty can be allocated a particular securities position because of the size rule and the sign rule, then the allocation takes place before the fourth rule is applied. According to the sorting rule, unallocated financial instruments are ranked in descending order of aggregate risk, and counterparties are sorted in descending order of the difference between initial position risk and position risk following each allocation.

A change in the risk position of the counterparties resulting from the allocated securities positions is calculated. As used herein, the term “risk position” refers to extent of exposure to a risk determined based on the security positions held by a counterparty. Acceptable change in the risk position is, for example, determined with reference to each of the counterparties. A hedging amount for hedging the calculated change in the risk position of the counterparties is calculated. The hedging amount is, for example, the amount of UST hedge that is to be bought or sold to restore the overall risk position for each of the counterparties to that before allocation. The calculated hedging amount is assigned to each of the counterparties.

When the counterparties have finished accepting or rejecting the created consensus price for each of the acquired securities positions, the sorting algorithm generates transactions which consolidate the holdings of each of the securities positions, such that generally the total holdings of a security position across all counterparties are assigned to a single counterparty, and so each of the counterparties who has a position in that security will either close out the position or increase the position at the created consensus price. The result is that each of the counterparties will have fewer securities positions or larger securities positions and hence more marketable positions, the desired line-item reduction referred to above, and the securities positions which have been reduced, eliminated or consolidated will have been done so at institutional mid-market price. The number of different securities held by each of the counterparties is reduced such that change of risk position is within constraints imposed by the counterparties.

Any detriment to each of the counterparties for acquiring a larger holding in a particular security is offset by the reduction of other securities positions. The sorting algorithm allocates the securities positions by not changing the overall risk position of each the counterparties to a large extent. Hence, none of the counterparties experience a large change in interest rates or credit risk profiles.

Trade reports are generated for each of the counterparties. The trade reports comprise, for example, outcome of the allocation and details of the trade. The counterparties modify the trade amount for each trade. Different reports are generated and presented during and after the trade, providing trade information, for example, amount of risk reduced, amount of possible risk reduction not performed, etc. The trade reports are presented in, for example, tabular and graphical formats. The number of securities positions of the counterparties is reduced by trading the allocated securities positions to the counterparties associated with the allocated securities positions and eliminating the counterparties who reject the created consensus price for each of the securities positions.

Furthermore, the transactions resulting from the allocation and hedge calculations are generated. The confirmation of the generated transactions is generated and sent to the counterparties. These confirmations are communicated to the counterparties by, for example, a web page on the website hosted on the trade management server, electronic mail (email), short message service (SMS) messages, or other communication systems.

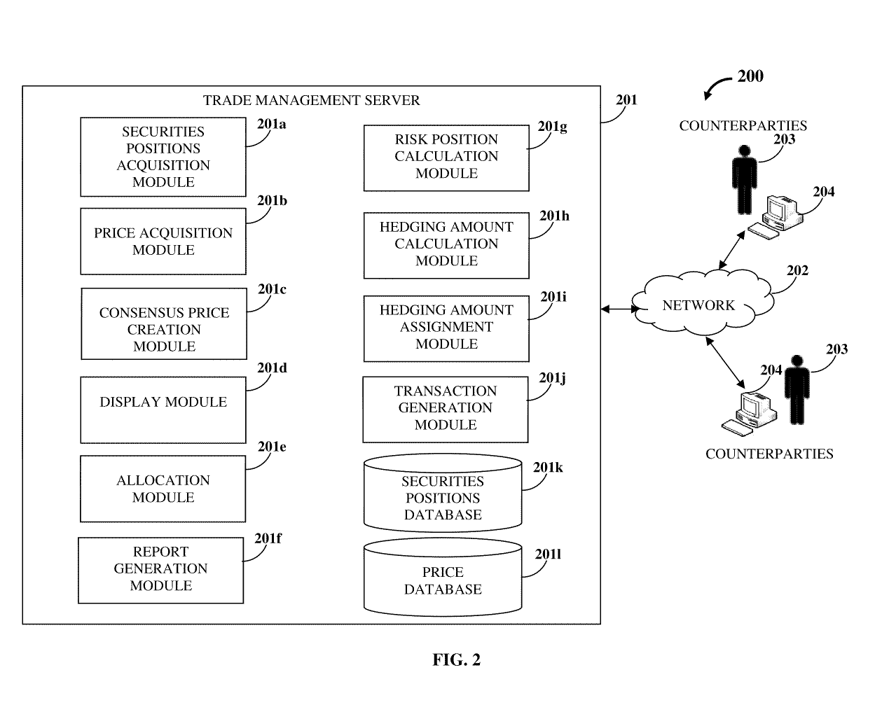

FIG. 2 illustrates a computer implemented system 200 for reducing the number of securities positions of multiple counterparties 203. The computer implemented system 200, for example, runs in discrete sessions. The computer implemented system 200 comprises a trade management server 201 remotely connected to a computing device 204 of each of the counterparties 203 via a network 202. The trade management server 201, for example, hosts a website. The counterparties 203, for example, buyers and sellers of the securities positions, access the website using their computing devices 204. The trade management server 201 comprises a securities positions acquisition module 201a, a price acquisition module 201b, a consensus price creation module 201c, a display module 201d, an allocation module 201e, a risk position calculation module 201g, a hedging amount calculation module 201h, an hedging amount assignment module 201i, a report generation module 201f, a transaction generation module 201j, a securities positions database 201k, and a price database 201l.

The securities positions acquisition module 201a acquires the securities positions comprising, for example, holdings of the counterparties 203 in one or more securities positions, from the counterparties 203. The securities positions are, for example, odd lot positions and aged positions. The securities positions database 201k stores information on the acquired securities positions of the counterparties 203. The price acquisition module 201b obtains a price for each of the acquired securities positions from each of the counterparties 203 associated with the acquired securities positions. The consensus price creation module 201c creates a consensus price for each of the acquired securities positions based on the obtained price of each of the acquired securities positions. The price database 201l stores pricing information based on the obtained price and the created consensus price of the acquired securities positions.

The display module 201d displaying the created consensus price for each of the acquired securities positions on, for example, the website hosted by the trade management server 201, to the counterparties 203. The counterparties 203 view the created consensus for each of the securities positions on a display unit 306 on their computing devices 204, for example, personal computers, mobile phones, personal digital assistants (PDAs), laptops, palmtops, etc. The counterparties 203 may accept or reject the created consensus price. The trade management server 201 eliminates the counterparties 203 who reject the created consensus price of each of the acquired securities positions from allocation of the acquired securities positions.

The allocation module 201e allocates the acquired securities positions at the created consensus price to one or more counterparties 203 who accept the created consensus price using a sorting algorithm. The sorting algorithm allocates the acquired securities positions of each of the counterparties 203 based on predefined rules. The securities positions database 201k stores information on the allocated securities positions of the counterparties 203. The allocation module 201e allocates the acquired securities positions to one or more counterparties 203 at the created consensus price to consolidate the holdings of the securities positions and to reduce the number of different securities positions held by each of the counterparties 203 such that change of risk position is within constraints imposed by the counterparties 203.

The computer implemented system 200 uses a particular proprietary sorting algorithm that sorts and reallocates securities positions across counterparties 203 so that the number of securities positions is reduced without much of a change in risk exposure.

The risk position calculation module 201g calculates a change in risk position of the counterparties 203 resulting from the allocated securities positions. The hedging amount calculation module 201h calculates a hedging amount for hedging the calculated change in the risk position of the counterparties 203. The hedging amount assignment module 201i assigns the calculated hedging amount to each of the counterparties 203. The report generation module 201f generates trade reports for each of the counterparties 203. The trade reports comprise, for example, outcome of the allocation and details of the trade. The display module 201d displays the trade reports on the website for viewing by the counterparties 203 using their computing devices 204. The transaction generation module 201j generates transactions resulting from the allocation and hedge calculations. The transaction generation module 201j sends a confirmation of the generated transactions to the counterparties 203 by, for example, a web page on the website hosted on the trade management server 201, electronic mail (email), short message service (SMS) messages, or other communication systems.

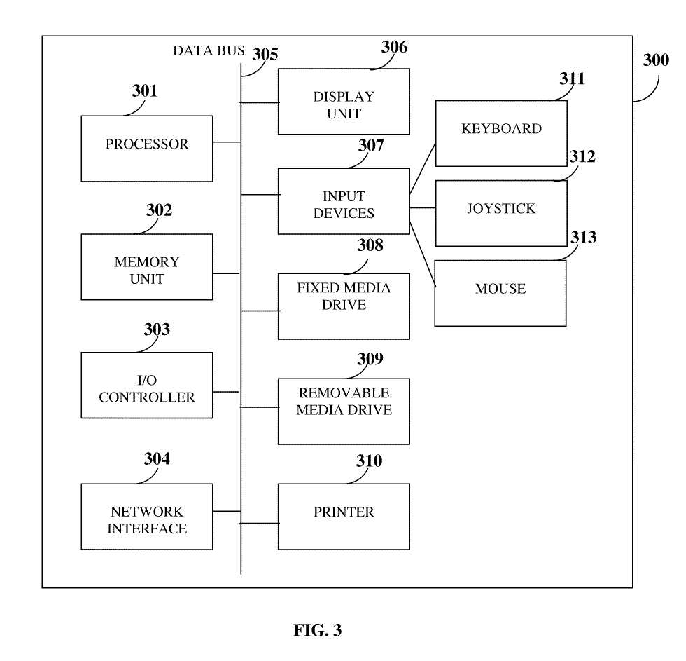

FIG. 3 exemplarily illustrates the architecture of a computer system 300 employed in the trade management server 201 and the computing devices 204 used by the counterparties 203 in a network 202.

The computing devices 204 are, for example, personal computers, mobile phones, personal digital assistants (PDAs), laptops, palmtops, etc. The computer system 300 of the computing device 204 of each of the counterparties 203 and the trade management server 201 comprises a processor 301, a memory unit 302 for storing programs and data, an input/output (I/O) controller 303, a network interface 304, a display unit 306, input devices 307, a fixed media drive 308, a removable media drive 309, and output devices, for example, a printer 310, communicating via a data bus 305. The output devices receive and read digital data on a compact disk, a digital video disk or other medium.

The processor 301 is an electronic circuit that executes computer programs. The memory unit 302 is used for storing programs and applications. The memory unit 302 is, for example, a random access memory (RAM) or another type of dynamic storage device that stores information and instructions for execution by the processor 301. The memory unit 302 also stores temporary variables and other intermediate information used during execution of the instructions by the processor 301. The computer system 300 further comprises a read only memory (ROM) or another type of static storage device that stores static information and instructions for the processor 301. The network interface 304 enables connection of the computer system 300 to the network 202. The I/O controller 303 controls the input and output actions performed by the counterparties 203. The data bus 305 permits communication between the modules, for example, 201a, 201b, 201c, 201d, 201e, 201f, 201g, 201h, 201i, and 201j of the trade management server 201.

The display unit 306 displays computed results to the counterparties 203. The input devices 307 are used for inputting data into the computer system 300. The input devices 307 are, for example, a keyboard 311 such as an alphanumeric keyboard, a joystick 312, a mouse 313, etc. The computer system 300 further comprises a fixed media drive 308 and a removable media drive 309 for receiving removable media. The computer system 300 on the computing device 204 communicates with the computer system of the trade management server 201 and other computer systems through the network interface 304.

Computer applications and programs are used for operating the computer system 300. The programs are loaded onto the fixed media drive 308 and into the memory unit 302 of the computer system 300 via the removable media drive 309. In an embodiment, the computer applications and programs may be loaded directly through the network 202. Computer applications and programs are executed by double clicking a related icon displayed on the display unit 306 using one of the input devices 307. The counterparties 203 interact with the computer system 300 using a graphical user interface (GUI) of the display unit 306.

The computer system 300 of the trade management server 201 employs an operating system for performing multiple tasks. The operating system is responsible for the management and coordination of activities and the sharing of the resources of the computer system 300. The operating system further manages security of the computer system 300, peripheral devices connected to the computer system 300, and network connections. The operating system employed on the computer system 300 recognizes, for example, inputs provided by the counterparties 203 using one of the input devices 307, the output display, files and directories stored locally on the fixed media drive 308, etc. The operating system on the computer system 300 executes different programs initiated by the counterparties 203 using the processor 301. The processes and threads are signals sent by the operating system to the processor 301 for processing information on different securities positions entered by the counterparties 203. The operating system on the computing device 204 records the acceptance and rejection of the created consensus price of each of the acquired securities positions by the counterparties 203 and transfers the information to the trade management server 201.

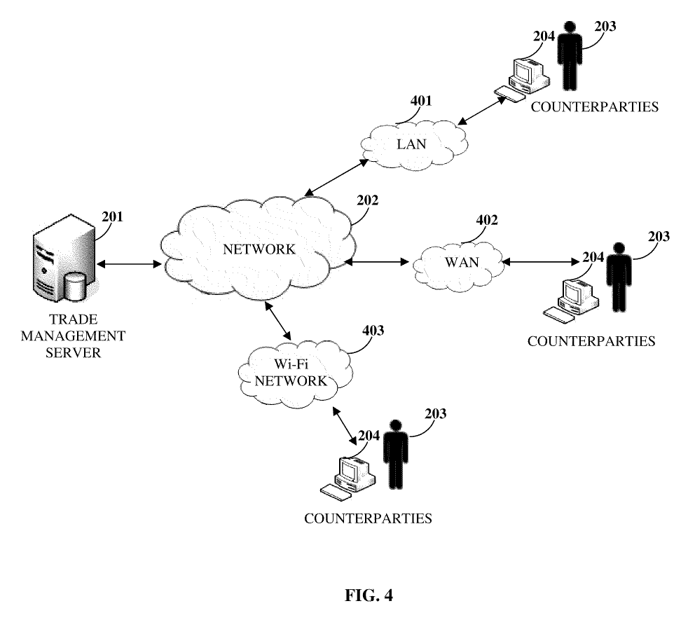

The trade management server 201 communicates with the counterparties 203 via a network 202, for example, a local area network (LAN) 401, a wide area network (WAN) 402, a Wi-Fi network 403, etc. as exemplarily illustrated in FIG. 4. Instructions for executing the functions performed by the trade management server 201 are retrieved by the processor 301 from the program memory in the form of signals. The location of the instructions in the program memory is determined by a program counter (PC). The program counter stores a number that identifies the current position in the program.

The instructions fetched by the processor 301 from the program memory after being processed are decoded. After processing and decoding, the processor 301 executes the instructions. For example, the securities positions acquisition module 201a defines the instructions for acquiring the securities positions from the counterparties 203. The price acquisition module 201b defines the instructions for obtaining a price for each of the acquired securities positions from each of the counterparties 203 associated with the acquired securities positions. The consensus price creation module 201c defines the instructions for creating a consensus price for each of the acquired securities positions based on the obtained price of each of the acquired securities positions. The allocation module 201e defines the instructions for allocating the acquired securities positions at the created consensus price to one or more counterparties 203 who accept the created consensus price, using a sorting algorithm. The risk position calculation module 201g defines the instructions for calculating a change in risk position of the counterparties 203 resulting from the allocated securities positions. The hedging amount calculation module 201h defines the instructions for calculating a hedging amount for hedging the calculated change in the risk position of the counterparties 203. The hedging amount assignment module 201i defines the instructions for assigning the calculated hedging amount to each of the counterparties 203. The report generation module 201f defines the instructions for generating trade reports for each of the counterparties 203. The transaction generation module 201j defines the instructions for generating transactions resulting from the allocation and hedge calculations.

The processor 301 retrieves the instructions defined by the securities positions acquisition module 201a, the price acquisition module 201b, the consensus price creation module 201c, the allocation module 201e, the risk position calculation module 201g, the hedging amount calculation module 201h, the hedging amount assignment module 201i, the report generation module 201f, the transaction generation module 201j, etc. and executes the instructions.

FIG. 4 exemplarily illustrates multiple counterparties 203 connected to the trade management server 201 via the network 202, for example, LAN 401, WAN 402, Wi-Fi network 403, etc. The LAN 401 comprises different network topologies. The LAN 401 uses different network protocols for communicating with the computing devices 204. The LAN 401, for example, comprises a peer-to-peer architecture or client-server architecture. The physical layer of the LAN 401 is, for example, made of twisted-pair wire, coaxial cables, fiber optic cables, etc. The securities positions of the counterparties 203 are acquired from the computing device 204 of the counterparties 203 through the network 202 by the trade management server 201. The counterparties 203 may log in to any of the computing devices 204 connected to the trade management server 201 via the network 202 and communicate with the trade management server 201 for accepting or rejecting the consensus price, viewing the trade reports of the allocated securities positions, etc.

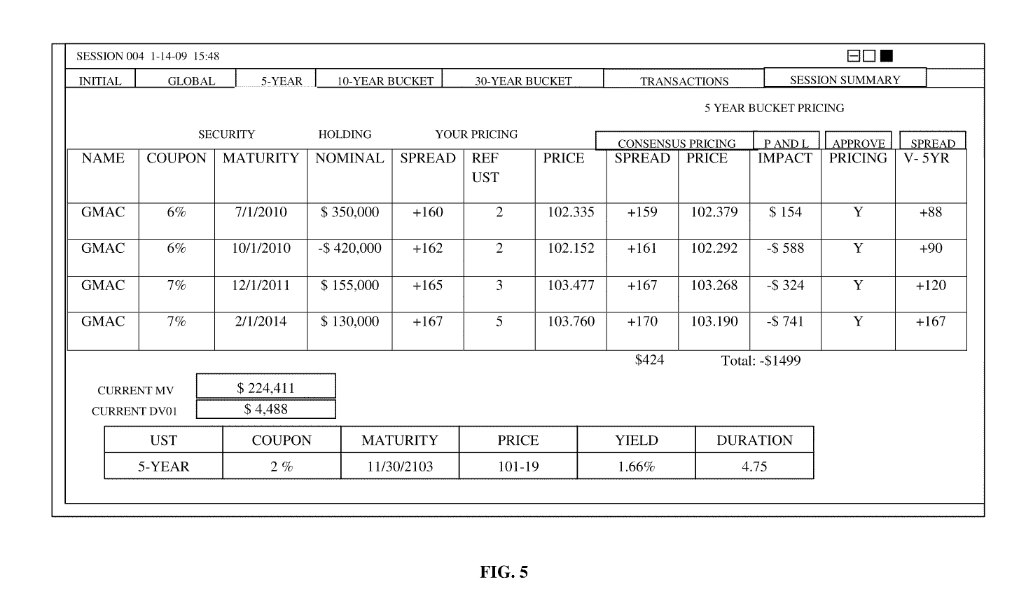

FIG. 5 exemplarily illustrates the submission of securities positions information from one of the counterparties 203. The computer implemented system 200 disclosed herein facilitates multilateral brokerage. The computer implemented system 200 is run in discrete sessions. Each session requires the participation of a number of counterparties 203, for example, three or more trading firms who submitted their holdings in a specified group of securities positions. The group of securities positions is, for example, defined by maturity, issuer, guarantor, credit quality etc.

The securities positions information is, for example, submitted in different formats or different means. The securities positions information is, for example, used to identify individual securities positions owned by counterparties 203, the size of holdings of each of the securities positions, and the price of the securities positions. Consider for example, securities in the form of group of bonds. The group of bonds are split and allocated to a number of maturity buckets, for example 5 years, 10 years, and 30 years and each of the maturity buckets are associated with a United States treasury (UST) bond of maturity appropriate to the selected bucket, for example, a UST hedge bond. The UST hedge bond is a recently issued UST bond with a maturity equal to one of the maturity buckets. Once the bonds are split the application of the computer implemented system 200 performs allocation of the securities separately to the securities in different buckets.

Information in the acquired bonds is used for calculation of a consensus spread and a consensus price for each of the bonds. Each of the counterparties 203 sees the results of the submitted information and the consensus price, but not the information of the other counterparties 203. Each of the counterparties 203 chooses to accept or reject the consensus price of each of the bonds. A rejection of the consensus price by one of the counterparties 203 does not affect the consensus price reported to all counterparties 203. Each of the counterparties 203 see the dollar value of the difference between the consensus price and the price submitted, which facilitates decision of accepting or rejecting the consensus price.

An acceptance of the consensus price, for example, commits the counterparties 203 to trade the bonds at consensus price using the sorting algorithm without prior knowledge of selling or buying of the securities.

Once all counterparties 203 finalize acceptance or rejection of the consensus price, a sorting algorithm consolidates holdings and allocates positions for the securities such that each of the counterparties 203 has a reduced number of securities. The sorting algorithm increases the size of any one of the holdings in the securities that is not reduced to zero.

For bonds, the sorting algorithm ensures that the relevant risk position, interest rate exposure of each of the counterparties 203 is as defined by dollar duration or by dollar value of a change of one-hundredth of one percent of bond yield for all bonds held (DV01). Furthermore, calculation of risk position after the allocation of bonds does not change significantly from the calculation of the risk position before allocation. The acceptable change in interest rate exposure is provided by each of the counterparties 203. For other securities, the algorithm ensures that market exposure defined by beta, delta or other appropriate measure is not altered beyond approved limits. Each of the counterparties 203 is made aware that the greater the permitted change in interest rate exposure, greater is the reduction of the number of securities.

For securities other than bonds, an instrument used to hedge any change of risk position following allocation known as a hedging instrument, is for example a stock index futures contract, forward contract, other securities or derivatives. Following the allocation of securities, the computer implemented system 200 determines hedging amount.

Furthermore, sum total of all changes in risk positions for all participating counterparties 203 is zero because the allocation is a closed system. Hence, the sum total of all hedging amounts is also zero. The computer implemented system 200 allocates to each of the counterparties 203 the hedge amount which involves some counterparties 203 selling the hedging instrument and other counterparties 203 buying. As used herein, the term “hedging instrument” refers to an instrument used to hedge any change of risk position following the allocation. The computer implemented system 200, for example, rounds up or rounds down the hedge amounts to the nearest $100,000 nominal or notional amount or other round amount as the counterparties 203 request or require.

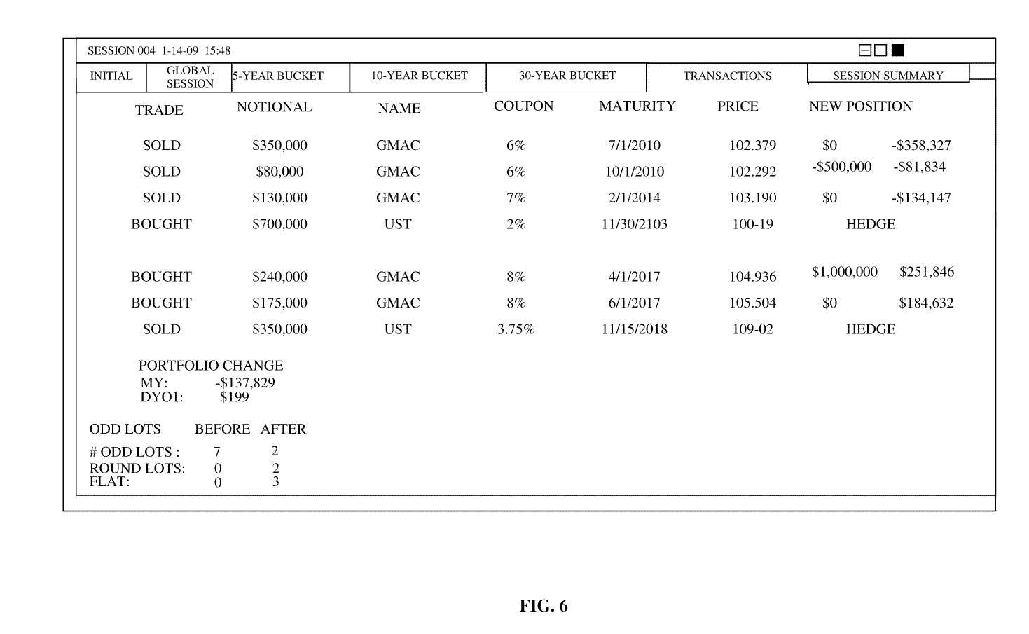

FIG. 6 exemplarily illustrates a generated trade report of allocated securities. The computer implemented system 200 disclosed herein reports to each of the counterparties 203 transactions produced by the computer implemented system 200 and generates transaction confirmations. The transaction confirmations are communicated between the computing device 204 of the counterparties 203 and the trade management server 201 by, for example, web page, email or other communications systems. The counterparties 203, for example, store the trade information provided in the trade report on the computing device 204 for further analysis. The counterparties 203, for example, download the information of the trade into a spreadsheet processing program.

It will be readily apparent that the various methods and algorithms described herein may be implemented in a computer readable medium appropriately programmed for general purpose computers and computing devices. Typically a processor, for example, one or more microprocessors will receive instructions from a memory or like device, and execute those instructions, thereby performing one or more processes defined by those instructions. Further, programs that implement such methods and algorithms may be stored and transmitted using a variety of media, for example, computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, central processing unit (CPU) devices, computing devices, microcontrollers, digital signal processors or like devices. The term “computer readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include dynamic random access memory (DRAM), which typically constitutes the main memory. Transmission media include coaxial cables, copper wire and fiber optics, including the wires that comprise a system bus coupled to the processor. Common forms of computer readable media include, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, a carrier wave as described hereinafter, or any other medium from which a computer can read. In general, the computer readable programs may be implemented in any programming language. Some examples of languages that can be used include C, C++, C#, or JAVA. The software programs may be stored on or in one or more mediums as an object code. A computer program product comprising computer executable instructions embodied in a computer readable medium comprises computer parsable codes for the implementation of the processes of various embodiments.

Where databases are described such as the securities positions database 201k and the price database 201l, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, UltraSPARC® processors, Sun® processors, IBM® processors, etc. that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method of reducing number of securities positions of a plurality of counterparties, comprising:
acquiring said securities positions from said counterparties, wherein said securities positions comprise holdings of said counterparties;
obtaining a price for each of said acquired securities positions from each of said counterparties associated with said acquired securities positions;
creating a consensus price for each of said acquired securities positions based on said obtained price of each of said acquired securities positions;
displaying said created consensus price for each of said acquired securities positions in an online environment to said counterparties, wherein said counterparties perform one of acceptance and rejection of said created consensus price of each of said acquired securities positions; and
allocating said acquired securities positions at said created consensus price to one or more counterparties who accept said created consensus price, using a sorting algorithm;
whereby said number of securities positions of said counterparties is reduced by trading said allocated securities positions to associated counterparties and eliminating said counterparties who reject said created consensus price for each of said securities positions.

2. The computer implemented method of claim 1, wherein said counterparties are buyers and sellers of said securities positions.

3. The computer implemented method of claim 1, further comprising:
calculating a change in risk position of said counterparties resulting from said allocated securities positions;
calculating a hedging amount for hedging said calculated change in said risk position of said counterparties; and
assigning said calculated hedging amount to each of said counterparties.

4. The computer implemented method of claim 1, further comprising generating trade reports for each of said counterparties, wherein said trade reports comprise outcome of said allocation and details of said trade.

5. The computer implemented method of claim 1, wherein said securities positions are odd lot positions and aged positions of said counterparties.

6. The computer implemented method of claim 1, wherein said allocation of said acquired securities positions to said one or more counterparties at said created consensus price is performed to consolidate said holdings of said securities positions and to reduce the number of different securities held by each of said counterparties such that change of risk position is within constraints imposed by said counterparties.

7. The computer implemented method of claim 1, further comprising generating transactions resulting from said allocation and hedge calculations, wherein a confirmation of said generated transactions is sent to said counterparties.

8. A computer implemented system for reducing number of securities positions of a plurality of counterparties, comprising:
a trade management server remotely connected to a computing device of each of said counterparties via a network, comprising:
a securities positions acquisition module that acquires said securities positions from said counterparties, wherein said securities positions comprise holdings of said counterparties in one or more securities positions;
a price acquisition module that obtains a price for each of said acquired securities positions from each of said counterparties associated with said acquired securities positions;
a consensus price creation module that creates a consensus price for each of said acquired securities positions based on said obtained price of each of said acquired securities positions;
a display module that displays said created consensus price for each of said acquired securities positions in an online environment to said counterparties, wherein said counterparties perform one of acceptance and rejection of said created consensus price of each of said acquired securities positions; and
an allocation module that allocates said acquired securities positions at said created consensus price to one or more counterparties who accept said created consensus price, using a sorting algorithm.

9. The computer implemented system of claim 8, wherein said trade management server further comprises a risk position calculation module that calculates a change in risk position of said counterparties resulting from said allocated securities positions.

10. The computer implemented system of claim 9, wherein said trade management server further comprises a hedging amount calculation module that calculates a hedging amount for hedging said calculated change in said risk position of said counterparties.

11. The computer implemented system of claim 10, wherein said trade management server further comprises an hedging amount assignment module that assigns said calculated hedging amount to each of said counterparties.

12. The computer implemented system of claim 8, wherein said trade management server further comprises a report generation module that generates trade reports for each of said counterparties, wherein said trade reports comprise outcome of said allocation and details of said trade, wherein said trade reports are displayed on said computing device of each of said counterparties in said online environment by said display module.

13. The computer implemented system of claim 8, wherein said allocation module allocates said acquired securities positions to said one or more counterparties at said created consensus price to consolidate said holdings of said securities positions and to reduce the number of different securities positions held by each of said counterparties such that change of risk position is within constraints imposed by said counterparties.

14. The computer implemented system of claim 8, wherein said trade management server further comprises a transaction generation module that generates transactions resulting from said allocation and hedge calculations, wherein said transaction generation module sends a confirmation of said generated transactions to said counterparties.

15. The computer implemented system of claim 8, wherein said trade management server further comprises a securities positions database that stores information on said acquired securities positions of said counterparties, wherein said acquired securities positions are one or more of odd lot positions and aged positions of said counterparties, wherein said securities positions database further stores information on said allocated securities positions of said counterparties.

16. The computer implemented system of claim 8, wherein said trade management server further comprises a price database that stores pricing information based on said obtained price and said created consensus price of said acquired securities positions.

17. A computer program product comprising computer executable instructions embodied in a computer readable storage medium, wherein said computer program product comprises:
a first computer parsable program code for acquiring securities positions from a plurality of counterparties, wherein said securities positions comprise holdings of said counterparties;
a second computer parsable program code for obtaining a price for each of said acquired securities positions from each of said counterparties associated with said acquired securities positions;
a third computer parsable program code for creating a consensus price for each of said acquired securities positions based on said obtained price of each of said acquired securities positions;
a fourth computer parsable program code for displaying said created consensus price for each of said acquired securities positions in an online environment to said counterparties, wherein said counterparties perform one of acceptance and rejection of said created consensus price of each of said acquired securities positions; and
a fifth computer parsable program code for allocating said acquired securities positions at said created consensus price to one or more counterparties who accept said created consensus price, using a sorting algorithm.

18. The computer program product of claim 17, further comprising:
a sixth computer parsable program code for calculating a change in risk position of said counterparties resulting from said allocated securities positions;
a seventh computer parsable program code for calculating a hedging amount for hedging said calculated change in said risk position of said counterparties; and
an eighth computer parsable program code for assigning said calculated hedging amount to each of said counterparties.

19. The computer program product of claim 17, further comprising a ninth computer parsable program code for generating trade reports for each of said counterparties, wherein said trade reports comprise outcome of said allocation and details of said trade.
